(19) United States
(12) Patent Application Publication
(10) Pub. No.: US 2023/0326307 A1
(43) Pub. Date: Oct. 12, 2023

(54) NUISANCE ALERT SYSTEM

(71) Applicants: Action-CS, Marysville, WA (US); OnView Integrated Solutions, Fremont, CA (US)

(72) Inventors: Justin Gant, Lynnwood, WA (US); Nicholas Schmidt, Mukilteo, WA (US)

(73) Assignees: Action-CS, Marysville, WA (US); OnView Integrated Solutions, Fremont, CA (US)

(21) Appl. No.: 18/055,316

(22) Filed: Nov. 14, 2022

Related U.S. Application Data
(60) Provisional application No. 63/278,698, filed on Nov. 12, 2021.
(60) Provisional application No. 63/371,829, filed on Aug. 18, 2022.

(51) Int. Cl. G08B 13/00

(52) U.S. Cl. CPC G08B 13/00

(57) ABSTRACT

In one aspect, a nuisance alert system configured to provide at least one of surveillance and active deterrence of any unwanted activity in a securable location, includes at least one notifier configured to output at least one signal in response to activation of the at least one notifier by a user in a securable location, and at least one output device configured to be triggered in response to the at least one signal generated by the at least one notifier, the at least one output device configured to, when triggered, provide one of surveillance and active deterrence of any unwanted activity in the securable location.

### CROSS-REFERENCE TO RELATED APPLICATIONS

This application claims the benefit of U.S. Provisional Application No. 63/278,698, filed on Nov. 12, 2021, and U.S. Provisional Application No. 63/371,829, filed on Aug. 18, 2022, the contents of which are incorporated herein by reference in their entirety.

### BACKGROUND

A building or another securable space, such as a retail store, a mall, a home, a commercial facility (e.g., an office building, manufacturing plant, warehouse, etc.), an airport, a multi-family dwelling, a parking lot, or any other space, is always susceptible to nuisance behaviors from others, such as break-ins, theft, squatting, physical assault, etc. Although first responders make every effort to respond to a situation in a timely manner, it can often be too late or the first responders may not be dispatched at all for a minor situation. Thus, building owners and management personnel may desire to take control of at least some security, safety, and/or surveillance measures.

Systems and methods provided herein are related to managing access, surveillance, safety, and security of a building or other space.

### SUMMARY

In one aspect, a nuisance alert system configured to provide at least one of surveillance and active deterrence of any unwanted activity in a securable location, includes at least one notifier configured to output at least one signal in response to activation of the at least one notifier by a user in a securable location, and at least one output device configured to be triggered in response to the at least one signal generated by the at least one notifier, the at least one output device configured to, when triggered, provide one of surveillance and active deterrence of any unwanted activity in the securable location.

In one aspect, a method of providing at least one of surveillance and active deterrence of any unwanted activity in a securable location, includes outputting, with at least one notifier, at least one signal in response to activation of the at least one notifier by a user in a securable location, triggering, by a computing device, at least one output device, in response to the at least one signal generated by the at least one notifier, and providing, by the at least one output device, one of surveillance and active deterrence of any unwanted activity in the securable location.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic illustration of a non-limiting example embodiment of a nuisance alert system according to various aspects of the present disclosure.

FIG. 2 is a block diagram that illustrates aspects of a non-limiting example embodiment of a notifier according to various aspects of the present disclosure.

FIG. 3 is a block diagram that illustrates aspects of a non-limiting example embodiment of a gateway assembly according to various aspects of the present disclosure.

FIG. 4 is a block diagram that illustrates aspects of a non-limiting example embodiment of a controller according to various aspects of the present disclosure.

FIG. 5 is a block diagram that illustrates aspects of a non-limiting example embodiment of a back end server according to various aspects of the present disclosure.

FIG. 6 is a swim diagram relating to a nuisance alert system according to various aspects of the present disclosure.

FIG. 7 illustrates a routine 700 in accordance with one embodiment.

FIG. 8 is a block diagram that illustrates a non-limiting example embodiment of a computing device appropriate for use as a computing device with embodiments of the present disclosure.

### DETAILED DESCRIPTION

Systems and methods described herein can be used to manage a building or a portion of a building or another securable space, such as a retail store, a mall, a home, a commercial facility (e.g., an office building, manufacturing plant, warehouse, etc.), an airport, a multi-family dwelling, a parking lot, or any other space, building or securable location (hereinafter sometimes collectively referred to as a “building” or “securable location”, etc.). Using the systems and methods described herein, a resident, manager, employee, or other authorized personnel associated with the securable location may generate an alert when a nuisance is detected, and the alert may trigger at least one security measure output, such as an alarm, audio/video/image recording; a dispatch of security personnel, a lockdown of at least a portion of the securable location, etc. Furthermore, the nuisance alert system 102 is configured to allow personnel in the securable location to receive information regarding security or other nuisances pertaining to the space. In that regard, the systems and methods described herein are generally configured to provide surveillance, safety, and/or active deterrence of any unwanted activity in a securable location.

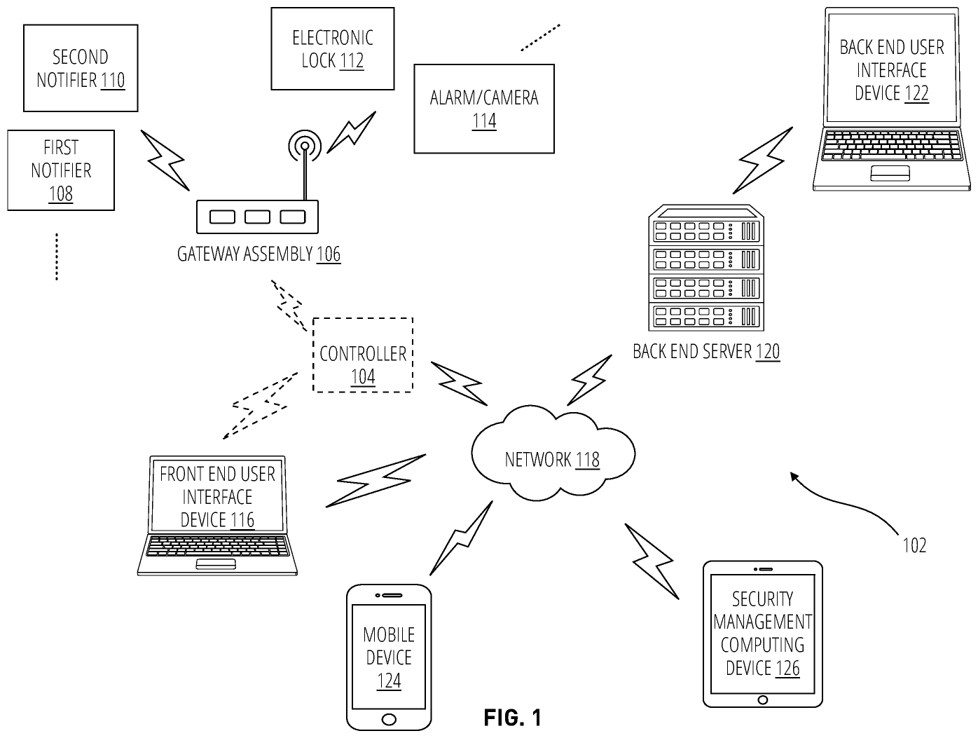

FIG. 1 is a schematic illustration of a non-limiting example of a nuisance alert system 102 according to various aspects of the present disclosure. The nuisance alert system 102 is generally configured to provide surveillance, safety, and/or active deterrence of any unwanted activity in a securable location, as briefly discussed above.

In one embodiment, the nuisance alert system 102 may be configured as a local or “basic” system with at least some, if not all of the components of the system located at the securable location (i.e., the location in which surveillance and/or active deterrence of any unwanted activity is desired). In this basic system, the nuisance alert system 102 may include a controller 104 in communication with a gateway assembly 106. The gateway assembly 106 is in communication with at least one “notifier” device for sending/receiving notifications, such as a first notifier 108 and a second notifier 110. The notifiers are configured to send one or more signals to the gateway assembly 106 when a nuisance (e.g., an actual or a potential threat) is detected by a user in association with the notifier. The gateway assembly 106 processes the notifier signal(s) and outputs one or more signals to the controller 104.

The controller 104 processes any signals received from the gateway assembly 106 and outputs corresponding signals to one or more nuisance alert output devices, such as an electronic lock 112, an alarm/camera 114, etc. In other words, when an alert is generated with a notifier (such as the first notifier 108 or second notifier 110), a corresponding output device may be triggered to secure the location and/or deter any unwanted activity. A manager or other user of the nuisance alert system 102 for the secure location may control and/or monitor aspects of the system through a front end user interface device 116 located at the secure location or otherwise in communication with the controller 104 through suitable wired or wireless means.

In one embodiment, the nuisance alert system 102 may be configured as a “virtual” system with at least some of the control and/or surveillance and/or active deterrence components of the system located at a location remote from the securable location. In this virtual system, the nuisance alert system 102 may include the gateway assembly 106, first notifier 108, second notifier 110, electronic lock 112, alarm/camera 114, and controller 104 as discussed above, or similar components. However, in this virtual system, the controller 104 may be in networked communication with one or more other computing devices suitable for controlling, monitoring, or otherwise managing one or more aspects of the nuisance alert system 102. Moreover, the controller 104 of the virtual system may be located remotely from the securable location (e.g., it is a networked computing device), and/or at least some of the functionality of the controller 104 may be integrated into one or more platforms of a networked computing device.

The controller 104 or other networked computing device integrating at least some of the functions of the controller 104 may communicate with the gateway assembly 106 over a network 118. The network 118 may be any kind of network capable of enabling communication between the various components of FIG. 1. For example, the network 118 can be a WiFi network. The various devices may interface with the network 118 through wired and/or wireless communications links (not labeled).

The various networked computing devices of the nuisance alert system 102 may include the controller 104 and/or gateway assembly 106, as discussed above, a back end server 120 having at least one back end user interface device 122, a mobile device 124, and a security management computing device 126. Each of these networked computing devices will be described in further detail below. It should be appreciated that the networked computing devices, including any functionality of the networked computing devices, may be used in either the “basic” or “virtual” nuisance alert system 102 referenced above.

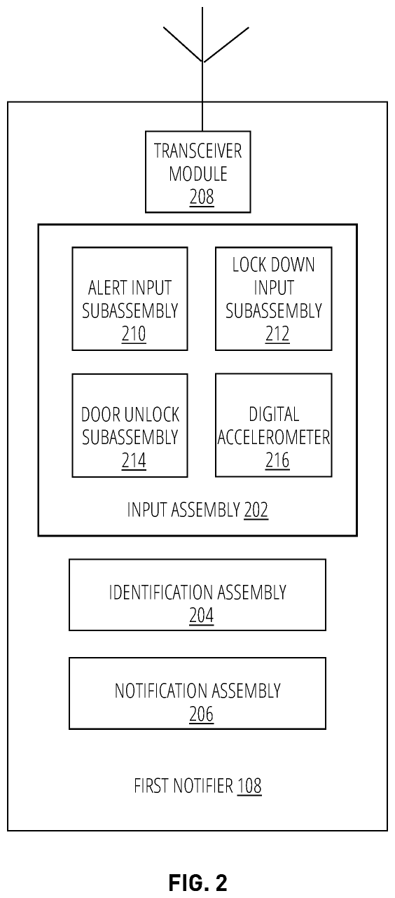

Turning to FIG. 2, exemplary aspects of notifiers for use with the nuisance alert system 102 (either the basic system, the virtual system, or any system combining some or all the aspects of the basic and virtual system) will be described. For ease of description, FIG. 2 shows an exemplary embodiment of the first notifier 108. It should be appreciated that aspects of the first notifier 108 may be included in the second notifier 110 or any other notifier used with the nuisance alert system 102. Accordingly, although the second notifier 110 or other notifiers are not shown or described in detail, some or all of the aspects of the first notifier 108 may be used for the second notifier 110 or any other notifier suitable for use with the nuisance alert system 102.

The first notifier 108 is generally configured to generate and/or receive one or more signals, either manually or automatically, when a nuisance is detected, an action should be taken by a user of the notifier, when registering or controlling the first notifier 108, etc. In that regard, the first notifier 108 generally includes an input assembly 202 for generating a trigger signal, an identification assembly 204 for generating a notifier identification signal, and a notification assembly 206 for providing a notification to the user of the first notifier 108.

The first notifier 108 further includes a transceiver module 208 for transmitting/receiving signals from the gateway assembly 106. For instance, the transceiver module 208 may transmit the trigger signal, the identification signal, and any other signal to the gateway assembly 106 (such as through or more antennas, not labeled). Further, the transceiver module 208 may receive at least one control signal from the gateway assembly 106, such as for triggering the notification assembly 206 or for providing system registration data to the identification assembly 204. Of course, the first gateway transceiver module 302 may be configured as a transceiver or as a separate notifier and receiver.

The transceiver module 208 may be configured to transmit/receive wireless signals and/or signals sent via wired means (e.g., a cable or optical fiber systems) to/from the gateway assembly 106. The signals associated with the transceiver module 208 may include wireless communication signals such as radio frequency, electromagnetics, local area network (LAN), wide area network (WAN), virtual private network (VPN), wireless network (using 802.11, for example), 245 MHz, Z-WAVE®, MQTT, Zigbee, cellular network (using 2G, LTE and/or 5G, for example), and/or other signals. The transceiver module 208 (including any antennas) may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, an antenna of the transceiver module 208 may receive signals or information specific and/or exclusive to itself. In some embodiments, the signals associated with the transceiver module 208 may include various wired connections.

The input assembly 202 includes at least one input device for generating a notifier signal that is processed by and outputted to the gateway assembly 106. In the embodiment shown, the input assembly 202 includes an alert input subassembly 210.

The alert input subassembly 210 may be configured to receive at least one analog or digital input from a user when the user wants to communicate at least one of a warning of nuisance activity to others, a request for surveillance of the securable location (such as video and/or audio and/or an image recording and/or monitoring), a request for an alarm (e.g., lights, siren, voice, etc.), or any other security operation or action that may be used to initiate surveillance, safety, and/or deterrence of unwanted activity in the securable location. In one embodiment, the alert input subassembly 210 includes a single button (mechanical or digital) that may be used to communication at least one of a variety of requests/commands. For instance, the user may press the button once to send a warning (e.g., a silent alert) of nuisance activity to others, such as management personnel associated with the securable location, other employees or personnel currently working at or otherwise residing in the securable location, etc. The silent alert warning may be embodied in an alert signal sent to the gateway assembly 106, which processes the alert signal for sending to the controller 104 and/or the back end server 120 for processing. In some embodiments, the user may press the button twice to initiate a request for an alarm. It can be appreciated that in other embodiments, the user may press the button more than twice to send one or more other signals.

In some embodiments, the user may press and hold the button for a certain length of time to send a warning, initiate a request, etc. In some embodiments, the alert input subassembly 210 may include a plurality of buttons, and the user may press and hold some or all of the buttons to send a warning, initiate a request, etc. For instance, the user may press and hold two buttons to send a request to lockdown a portion of the building (e.g., such as the cooler, liquor section, cash register area, etc.), and the user may press and hold three buttons to send a request to lockdown the entire building. It should be appreciated that any combination of button arrangements and input requirements/protocols may be used to generate a desired alert signal. Moreover, other input devices, such as switches, audio input devices for voice command (e.g., microphones), motion sensors, etc., may also be used.

The input assembly 202 may further include a lock down input subassembly 212, which may include one or more buttons (mechanical or digital) or other input devices (e.g., microphones for voice command) configured to send a signal(s) for activating a lock of a portion and/or all of the securable location. For instance, the lock down input subassembly 212 may include a single button that, when pressed once, sends a signal to lock down a portion of the building (e.g., such as the cooler, liquor section, cash register area, etc.). The user may press and hold the lock down button or press it twice, for example, to send a request to lockdown the entire building. As noted above with respect to the alert input subassembly 210, any combination of button arrangements and input requirements may be used to generate a desired lock down signal. In that regard, it should be appreciated that the lock down input subassembly 212 may be integrated into the alert input subassembly 210 (e.g., lock down signals may be sent via one or more of the input devices of the alert input subassembly 210). Moreover, other input devices, such as switches, audio input devices for voice command, etc., may also be used.

The input assembly 202 may further include a door unlock subassembly 214, which may include an identification device that, once verified (such as upon registration with the controller 104 and/or the back end server 120), outputs a signal indicating verification for access to a locked area. Any suitable identification device may be used, such as an RFID tag or key fob. In that regard, the nuisance alert system 102 may include a suitable identification device reader, such as an RFID tag/fob reader associated with an electronic lock of each secured area. The RFID tag/fob reader may output a signal to the corresponding electronic lock upon detection of a signal received from the RFID tag/fob for unlocking the secured area. The identification device of the door unlock subassembly 214 may be used to selectively unlock multiple areas of a building (based, for instance, on the permissions identified during registration), each area having an identification device reader.

The input assembly 202 may further include a digital accelerometer 216. The digital accelerometer 216 is configured to detect orientation, gesture, motion, etc., such that an accelerometer output signal(s) may be generated, for instance, when a user of the first notifier 108 falls or another event occurs. In some embodiments, the accelerometer output signal(s) may only be generated when a certain orientation, gesture, motion, etc., is detected for a certain period of time. In this regard, if the user of the first notifier 108 trips and falls but quickly gets back up, the digital accelerometer 216 will not output a signal, thereby avoiding false alarm.

The accelerometer output signal(s) of the digital accelerometer 216 may be processed by the gateway assembly 106 and the controller 104 (and/or the back end server 120) for carrying out one or more actions based on detection of a fall or other event. For instance, the controller 104 (and/or the back end server 120) may send one or more commands to other networked computing devices in order to begin audio and/or video monitoring/recording, dispatch security personnel/police, activate an alarm and/or lock down a portion of the building, initiate a communication session with the user, etc.

In the embodiment shown, the input assembly 202 includes an alert input subassembly 210, a lock down input subassembly 212, a door unlock subassembly 214, and a digital accelerometer 216. However, it should be appreciated that any suitable combination of input devices suitable for allowing a user to initiate surveillance, safety, and/or deterrence of unwanted activity in the securable location may instead be used.

As noted above, the first notifier 108 further includes an identification assembly 204. The identification assembly 204 may include suitable circuitry for outputting one or more signals indicative of a unique identification for the first notifier 108. The identification assembly 204 may also be configured to receive one or more identification request signals (such as registration request signals) from the gateway assembly 106. In some embodiments, the identification assembly 204 may output one or more signals, optionally in response to an identification request from the controller 104/back end server 120 through the gateway assembly 106, that indicate at least one of the notifier device information and user information associated with the notifier. The notifier device information may include, for example, model, make, serial number, IMEI, TCP/IP address, or any other network or device identifier. The user information for the user associated with the notifier, may include name, address, email, social security number, or any other personally identifiable information.

As noted above, the first notifier 108 further includes a notification assembly 206. The notification assembly 206 may be configured to provide a tactile, visual, and/or audible notification or other notification to the user of the first notifier 108 as a warning of nuisance activity, as an indication to take certain actions, etc. In that regard, the notification assembly 206 may include any suitable vibratory motors, speakers, lights, displays, etc., for providing a desired notification(s). In one example, the notification assembly 206 generates a vibration of the first notifier 108 (such as through a vibratory motor) upon receipt of a signal(s) from the gateway assembly 106. In another example, the notification assembly 206 generates an audible noise (e.g., a ding, an easily disguisable sound, such as the sound of a cough, etc.) (such as through a speaker) upon receipt of a signal(s) from the gateway assembly 106. In another example, the notification assembly 206 generates a visual indicator, such as a flashing light, a message (such as on a display), on the first notifier 108 upon receipt of a signal(s) from the gateway assembly 106. The gateway assembly 106 may send such a signal(s) to the notification assembly 206 in response to one or more signals received from, for instance, the controller 104 and/or the back end server 120. For instance, the controller 104 and/or the back end server 120 may send a signal to the gateway assembly 106 upon receipt of an alert signal from another notifier (associated with another user in the same building, for instance), upon receipt of a signal from a sensor in the building (e.g., a door was opened without authorization), or upon receipt of any other type of nuisance activity necessitating notification. It should be appreciated that any other suitable notification devices may instead be used, and any combination of the above may be used.

As can be appreciated from the foregoing, the first notifier 108 is configured to generate and/or receive one or more signals, either manually or automatically, when a nuisance is detected, an action should be taken by a user of the notifier, when registering or controlling the first notifier 108, etc. In that regard, the first notifier 108 and other notifiers of the nuisance alert system 102 may be any suitable device configured to send and/or receive signals, such as a wired button (e.g., beneath a sales counter), a smart watch, a wearable alert device (e.g., a wireless button), a smart tag/ID, a cellular phone or tablet having a notifier application or chip, etc.

For instance, a store clerk may press a button beneath a counter or on a wearable or portable device to send a signal indicating a nuisance, threat, concern, etc. The signal may indicate what, if any, actions should be taken by the controller 104 and/or the back end server 120. For instance, the signals may request that at least portion of the building should be locked down, that security personnel should be dispatched, that a video monitoring session should commence, etc.

In some embodiments, the nuisance alert system 102 may include suitable communications channels that allow for information to be sent and received between the notifiers. For example, the notifiers can form a mesh network, e.g., a Z-wave mesh network, such that each of the notifiers is a node along the network. The mesh network may eliminates the need for a communication channel between each of the notifiers in the network, or between each of the notifiers and the gateway assembly 106.

For example, if the second notifier 110 is not directly communicatively coupled to the gateway assembly 106, the second notifier 110 can send data to the first notifier 108, e.g., using the Z-wave or ZigBee, WiFi, cellular, or Bluetooth protocol. The first notifier 108, being communicatively coupled to the gateway assembly 106 (e.g., through the transceiver module 208), can receive the data from the second notifier 110 and send the data to the controller 104 and/or the back end server 120 by communicating the data to the gateway assembly 106. In such an example, each notifier that forms a node of the mesh network can send and receive information to the controller 104 and/or the back end server 120. An advantage of the mesh network is that when a notifier is added to the mesh network, it does not need to be directly communicatively coupled to the gateway assembly 106. This is advantageous if the gateway assembly 106 is located out of range of the newly added notifier.

In any event, the notifiers can be considered Z-Wave devices, Bluetooth devices, ZigBee devices, etc., running relevant profiles and packed in the form of a wired button, wearable device (e.g., a smart watch), a smart watch, a wearable alert device (e.g., a wireless button), a smart tag/ID, a cellular phone or tablet having a notifier application or chip, etc.

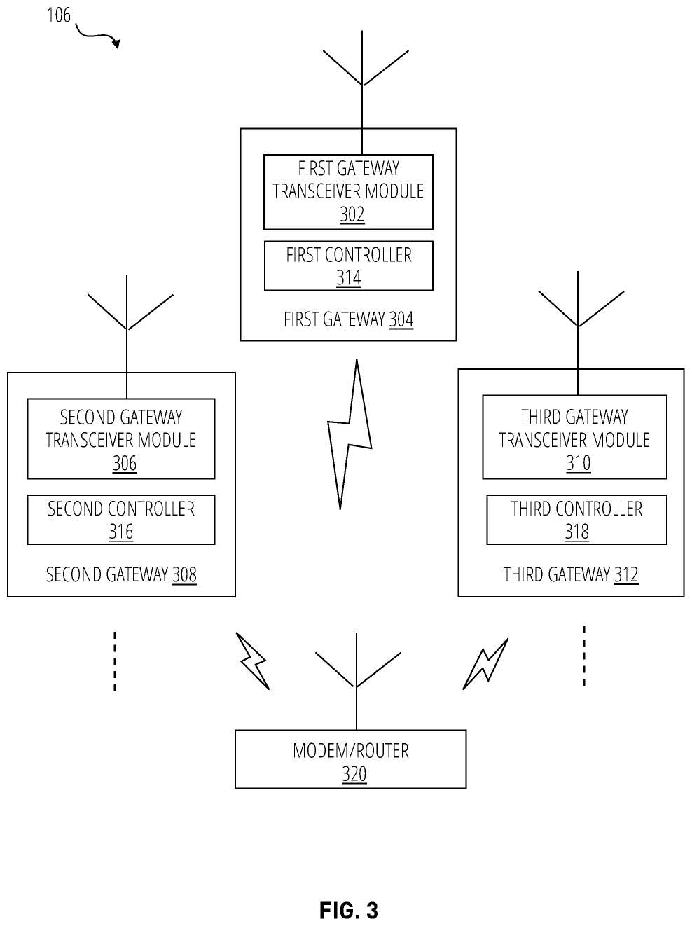

Referring to FIG. 3, the gateway assembly 106 will now be described. As briefly discussed above, the gateway assembly 106 is in communication with at least one notifier, such as a first notifier 108 and a second notifier 110. The notifiers are configured to send one or more signals to the gateway assembly 106 when a nuisance (e.g., an actual or a potential threat) is detected by a user in association with the notifier or the user otherwise wants to send an alert or request. The gateway assembly 106 processes the notifier signal(s) and outputs one or more signals to the controller 104 and/or the back end server 120. The gateway assembly 106 also processes any signals received from the controller 104 and/or the back end server 120 and outputs corresponding signals to the notifiers (e.g., for generating a notifier notification, registering the notifier device, etc.).

In some embodiment, such as the basic nuisance alert system 102 described above, the gateway assembly 106 may include at least one gateway communicatively coupled to the notifiers (e.g., the first notifier 108 and the second notifier 110) and the controller 104. In some embodiments, such as in the virtual nuisance alert system 102 described above, the gateway assembly 106 may include at least one gateway communicatively coupled to the notifiers and the controller 104 and/or the back end server 120. In the embodiment shown, the gateway assembly 106 includes a first gateway 304, a second gateway 308, and a third gateway 312; however, fewer or more may be included, depending on the footprint of the securable location or building. For instance, a plurality of gateways may be needed to ensure adequate signal coverage for sending/receiving signals to the notifiers.

Each gateway includes a transceiver module configured for sending/receiving signals to the notifiers and the controller 104 and/or the back end server 120. In the embodiment shown, the first gateway 304 includes a first gateway transceiver module 302, the second gateway 308 includes a second gateway transceiver module 306, and the third gateway 312 includes a third gateway transceiver module 310. Any suitable gateway transceiver module may be used for sending/receiving signals between the notifiers and the controller 104 and/or the back end server 120. Of course, the gateway transceiver modules may be configured as a transceiver or as a separate notifier and receiver.

The gateway transceiver modules may be configured to transmit/receive wireless signals and/or signals sent via wired means (e.g., a cable or optical fiber systems) to/from the notifiers and the controller 104 and/or the back end server 120. The signals associated with the gateway transceiver module may include wireless communication signals such as radio frequency, electromagnetics, local area network (LAN), wide area network (WAN), virtual private network (VPN), wireless network (using 802.11, for example), 245 MHz, Z-WAVE®, MQTT, Zigbee, cellular network (using 2G, LTE and/or 5G, for example), and/or other signals. The gateway transceiver modules (including any antennas) may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, an antenna of the transceiver module may receive signals or information specific and/or exclusive to itself. In some embodiments, the signals associated with the gateway transceiver modules may include various wired connections.

The gateway transceiver modules may incorporate the function of a modem and/or router, such as for the virtual nuisance alert system 102 or similar configurations requiring access to remove servers over a network. In some embodiments, a separate modem/router 320 is incorporated into the gateway assembly 106. The modem/router 320 is communicatively coupled to the first gateway 304, a second gateway 308, and a third gateway 312 using wireless or wired protocols now known or later developed, such as those protocols described herein. The gateway assembly 106 is configured to protect the wireless network data using security encryption methods such as WEP, WPA, and WPS, WPA2 with WPS disabled, or another method.

The gateways can be powered using power over Ethernet (POE) using a connection to a utility power grid, or using another source now known or later developed. Multiple gateways (such as the first gateway 304, the second gateway 308, and the third gateway 312) can be electrically connected in series using a single wire (e.g., a Cath cable), and the gateways can be powered using POE (e.g., POE++). Such a multiple gateway configuration beneficially results in limited physical deployment and wiring requirements during installation and upgrades.

Each gateway includes a gateway controller (e.g., a first controller 314, a second controller 316, and a third controller 318) configured to route packets from the wireless notifier LAN to the controller 104 and/or the back end server 120. In one embodiment, each gateway is configured as a Raspberry Pi 4 with a Z-Wave controller and the notifiers are configured as Z-wave devices.

The gateway controller may be configured to receive notifier device (e.g., z-wave) register requests from the controller 104 and/or the back end server 120. In response to such requests, the gateway controller may communicate with the identification assembly 204 of the respective notifier, as described above. The controller 104 and/or the back end server 120 can be configured to add the notifier device (e.g., using the information retrieved from the identification assembly 204 of the respective notifier) to a data store (such as data store 406 or data store 506), as discussed below. The gateway controller may also be configured to receive notifier device (e.g., z-wave) deletion requests and communicate with the identification assembly 204 of the respective notifier and the controller 104 and/or the back end server 120 to remove the notifier device from the data store.

The gateway controller may also be configured to receive signals indicating activities from added notifier devices (e.g., z-wave) and output signals indicating the activity details to the controller 104 and/or the back end server 120, such as using an MQTT protocol. The gateway controller may also be configured to receive notification signals, such as from another notifier device on the network or from the controller 104 and/or the back end server 120, and output signals to the notification assembly 206 of a notifier device.

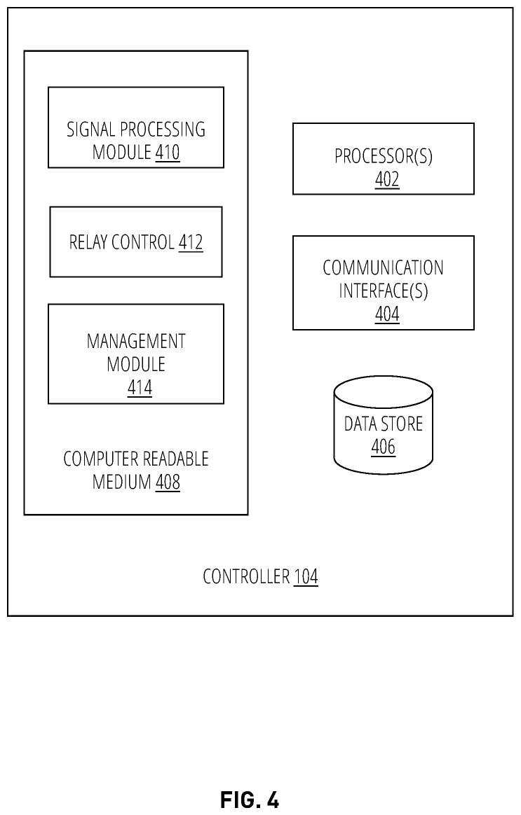

Referring to FIG. 4, exemplary aspects of the controller 104 will now be described. As noted above, the controller 104 can process any signals received from the gateway assembly 106 and output corresponding signals to one or or more nuisance alert output devices, such as the electronic lock 112, alarm/camera 114, etc. In other words, when a signal is generated with a notifier (such as the first notifier 108 or second notifier 110) or the back end server 120, the signal is sent to the gateway assembly 106, which processes the signal and outputs a corresponding signal to the controller 104. In response, the controller 104 may trigger an output device to secure the location and/or deter any unwanted activity.

As noted above, the controller 104 may be integrated into the back end server 120. Accordingly, when describing aspects of the controller 104, it should be appreciated that in some embodiments, such as the virtual nuisance alert system 102 discussed above, some or all aspects of the controller 104 are integrated into the back end server 120. Accordingly, any description of the controller 104 may be applied to the back end server 120.

The controller 104 may include one or more processor(s) 402, one or more communication interface(s) 404, a data store 406, and a computer readable medium 408.

In some embodiments, the communication interface(s) 404 include one or more hardware and or software interfaces suitable for providing communication links between components. The communication interface(s) 404 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

The data store 406 may store notifier device data and/or output device data received from the gateway assembly 106 for retrieval by any applications of the controller 104 and/or the back end server 120. The data store 142 may also store notifier device/gateway registration data, notification data, user information, email account information, secure account information or access data (e.g., login credentials), SMTP configuration data, test system data, system operation/log data, etc.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. For example, in some embodiments, a cloud service such as Google Cloud Storage or Azure cloud storage may be used as a data store. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As shown, the computer readable medium 408 has stored thereon logic that, in response to execution by the one or more processor(s) 402, cause the controller 104 to process gateway data for controlling one or more output devices and/or controlling one or more notifiers, to process data associated with registering devices, to process data received from user input (inputted through the controller 104 and/or the back end server 120) for managing the nuisance alert system 102, etc. For example, the computer readable medium 408 may include a signal processing module 410 generally configured to process gateway data, output device data, and any data sent from the back end server 120, a relay control 412 for controlling one or more output devices, and a management module 414 for managing the nuisance alert system 102.

The signal processing module 410 generally configured to process gateway data, output device data, and any data sent from the back end server 120 will first be described. As discussed above, the gateway assembly 106 processes the notifier device signal(s) and can output one or more signals to the controller 104. Thus, in one aspect, the signal processing module 410 of the controller 104 is configured to process the notifier device signals from the gateway assembly 106 and determine what, if any actions should be taken.

For instance, the signal processing module 410 may process and send gateway data (e.g., packaged notifier device data) to the data store 406 for retrieval by the relay control 412, the management module 414, or any applications on the back end server 120. The signal processing module 410 may also process and send gateway data directly to the relay control 412 for activating an output device. For instance, the signal processing module 410 may, based upon a processing of the gateway data, output one or more signals to the relay control 412 for triggering a relay to activate an output device.

The relay control 412 may be any suitable configuration for activating an output device(s) upon receipt of a trigger signal. For instance, the relay control 412 may include a relay and relay ground component for activating each of the output devices. For instance, the relay control 412 may include a first relay for activating the electronic lock 112 and a second relay for activating the alarm/camera 114. Of note, the alarm/camera 114 may include an IP camera and a camera adaptor device similar to what is shown and described in U.S. patent application Ser. No. 17/571,851 (now US20220224805), filed Jan. 11, 2021, entitled “Camera Adaptor”, the entire disclosure of which is hereby incorporated by reference herein.

In one example, the signal processing module 410 may, based upon a processing of the gateway data, output one or more signals to the relay control 412 for triggering a first relay to activate the alarm/camera 114 when an input initiating a request for an alarm is received from a notifier through the gateway assembly 106 (such as by depressing a single button on a notifier). In another example, the signal processing module 410 may, based upon a processing of the gateway data, output one or more signals to the relay control 412 for triggering a second relay to activate the electronic lock 112 when an input initiating a request for a partial or complete lock down is received from a notifier through the gateway assembly 106 (such as by depressing a two buttons on a notifier, pressing a button twice, etc.). In another example, the signal processing module 410 may, based upon a processing of the gateway data, output one or more signals to the relay control 412 for triggering a third relay to activate a notification device on the notification assembly 206 of one or more notifiers when an input initiating a request for an alert/silent alarm is received from a notifier through the gateway assembly 106 (such as by depressing three buttons on a notifier, pressing a button twice, etc.). It should be appreciated that any other relay/output configuration may instead be used.

The signal processing module 410 of the controller 104 may also process accelerometer output signal(s) routed via the gateway assembly 106 for determining whether a user of a notifier has fallen or a similar event has occurred. Based on the analysis, the controller 104 can send out email and/or push notifications to a local computing device, cellular device, tablet device, etc., in networked communication with the controller 104 to alert relevant personnel. In the case where the controller 104 is integrated into or otherwise in communication with the back end server 120, the back end server 120 may send one or more commands to other networked computing devices in order to begin audio and/or video monitoring/recording, dispatch security personnel/police, activate an alarm and/or lock down a portion of the building, initiate a communication session with the user of the notifier, etc.

The signal processing module 410 of the controller 104 may also process output device data and determine what, if any actions need to be taken. For instance, if a relay is triggered to turn on video and/or audio and/or image recording for an output device, the signal processing module 410 may be configured to send any video and/or audio and/or image data (processed and send via the gateway assembly 106) to the data store 406 and/or to another application (such as, for instance, to the management module 414 for viewing/listening by an administrator on the front end user interface device 116).

As noted above, the controller 104 includes a management module 414 for managing the nuisance alert system 102. The management module 414 is generally configured to provide an interface for controlling and/or monitoring aspects of the nuisance alert system 102. For instance, the management module 414 may be configured to provide a user interface associated with the controller 104 (such as on the front end user interface device 116) to register/enroll users, associate names with ids/emails, set up/add gateways, set up/add notifiers, set up/add output devices, email setup, SMTP configuration, test system, test operation, log in, pull logs, etc.

In one example, the management module 414 of the controller 104 may output one or more signals to the gateway assembly 106 for routing to a notifier for registering the notifier as an authorized device in the nuisance alert system 102. In that regard, the management module 414 may first receive notifier device information from the gateway assembly 106 for adding device information to, for instance, a registration database within the data store 406. As can be appreciated, a manager or other user of the nuisance alert system 102 for the secure location may control and/or monitor aspects of the system through the management module 414 of the controller 104.

As discussed above, if the nuisance alert system 102 is implemented as a virtual system or similar, the controller 104 may be in networked communication with one or more other computing devices, such as a back end server 120 suitable for controlling, monitoring, or otherwise managing one or more aspects of the nuisance alert system 102. Moreover, the controller 104 of the enhanced system may be located remotely from the securable location (e.g., it is a networked computing device), and/or at least some of the functionality of the controller 104 may be integrated into one or more platforms of a networked computing device such as the back end server 120. Moreover, if the nuisance alert system 102 includes multiple locations each having a controller 104, each of the controllers can communicate with the back end server 120 for central management of the nuisance alert system 102.

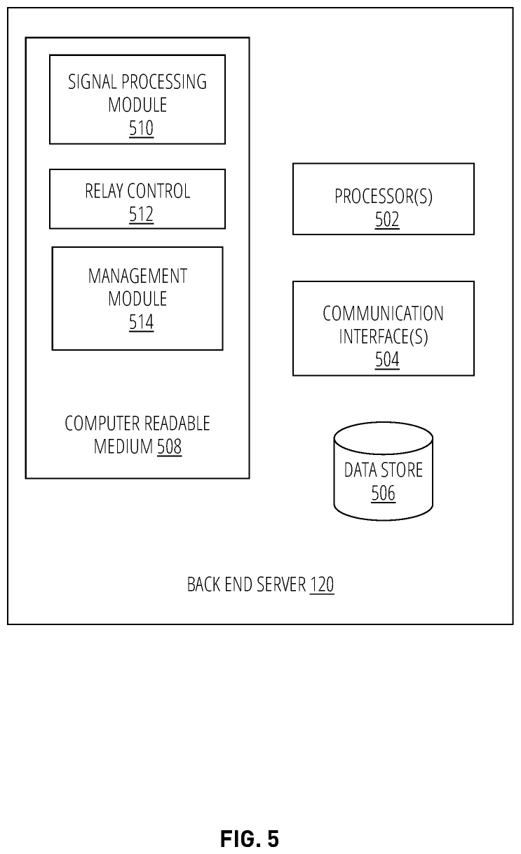

Referring to FIG. 5, exemplary aspects of the back end server 120 will now be described. The back end server 120 is any suitable networked computing device(s) configured for remotely and centrally controlling, monitoring, or otherwise managing one or more aspects of the nuisance alert system 102. The back end server 120 may be implemented by any computing device or collection of computing devices, including but not limited to a desktop computing device, a laptop computing device, a mobile computing device, a server computing device, a computing device of a cloud computing system, and/or combinations thereof.

Because the back end server 120 can be used to remotely manage devices of the nuisance alert system 102, it should be appreciated that in a virtual nuisance alert system 102 or similar, the one or more notifiers and/or output devices may be communicate directly with the back end server 120. In that regard, the notifier may be embodied as a mobile device 124 (e.g, cellular phone, tablet, smart watch, or similar) that can communicate directly with the back end server 120 through Wi-Fi, cellular signals, etc.

In the depicted embodiment, the back end server 120 includes one or more processor(s) 502, one or more communication interface(s) 504, a data store 506, and a computer readable medium 508. The one or more processor(s) 502, one or more communication interface(s) 504, and data store 506 of the back end server 120 may have similar attributes to the one or more processor(s) 402, one or more communication interface(s) 404, and data store 406 of the controller 104, and therefore will not be separately described.

The computer readable medium 508 of the back end server 120 may include a signal processing module 510, a relay control 512, and a management module 514. As noted above, aspects of the controller 104 may be integrated into the back end server 120. In that regard, the signal processing module 510, relay control 512, and management module 514 of the back end server 120 may be substantially identical to the signal processing module 410, relay control 412, and management module 414 of the controller 104 and/or will not be separately described except to summarize the functionality or to describe any functionality that may be beneficially carried out by or that is necessary for being carried out by the back end server 120 and not the on-site controller 104.

In that regard, the signal processing module 510 of the back end server 120 may be configured to process gateway data from the gateway assembly 106 for determining what, if any action to take. For instance, the signal processing module 510 may process and send gateway data (e.g., packaged notifier device data) to the data store 506 for retrieval by the relay control 512, the management module 514, or any other modules or applications on the back end server 120. The signal processing module 510 may also process and send gateway data directly to the relay control 512 for activating an output device. For instance, the signal processing module 510 may, based upon a processing of the gateway data (e.g., packaged notifier device data), output one or more signals to the relay control 512 for triggering a relay to activate an output device. If the notifier is a cellular phone, the signal processing module 510 can process signals sent from the cellular phone directly to the signal processing module 510 rather than processing the signals via the gateway assembly 106. Further, the signal processing module 510 can parse information from an accelerometer sensor and/or a global position system (GPS) chip.

The signal processing module 510 of the back end server 120 may also process output device data and determine what, if any actions need to be taken. For instance, if a relay is triggered to turn on video and/or audio and/or image recording for an output device, the signal processing module 510 may be configured to send any video and/or audio and/or image data (processed and send via the gateway assembly 106) to the data store 506 and/or to another application (such as, for instance, to the management module 514 for viewing/listening by an administrator on the back end user interface device 122). For example, the signal processing module 510 may be configured to send any video and/or audio and/or image data directly to a NAS channel on a cloud network video recorder (NVR).

The management module 514 of the back end server 120 may be generally configured to provide a centrally managed portal or interface for controlling and/or monitoring aspects of the nuisance alert system 102. For instance, the management module 514 may be configured to provide a user interface associated with the back end server 120 to manage aspects of the nuisance alert system 102. The user interface associated with the back end server 120 may be accessed on the back end user interface device 122 or another networked computing device. The back end user interface device 122 may be configured as a personal computing device, a mobile device, a tablet, a smart watch, etc.

In one example, the management module 514 may be configured to allow an administrator to register/enroll users, associate names with ids/emails, set up/add gateways, set up/add notifiers, set up/add output devices, email setup, SMTP configuration, test system, test operation, log in, pull logs, etc., as done by the management module 414 of the controller 104. In that regard, the management module 514 may be configured to allow an administrator to remotely log in for carrying out one or more management or administrative tasks.

In further aspects, the management module 514 may be configured to monitor each notifier and output device. For instance, the management module 514 can be used to see a status of each notifier (e.g., active/online, low/medium/full power, location, current notifications), incoming data from a notifier (e.g., video stream, audio stream, accelerometer data, triggered notifications, etc.), and any historical information (e.g., notification history, device health, updates, etc.). Similarly, the management module 514 can be used to see a status of each output device (e.g., active/online, low/medium/full power, location, lock status, alarms, etc.), incoming data from an output device (e.g., video stream, audio stream, etc.), and any historical information (e.g., output history, device health, updates, etc.).

In further aspects, the management module 514 may be configured to initiate a communication session with a remote monitoring/surveillance service for live conversation between a user of a notifier and/or output device (such as an voice down/IP camera system) and an administrator of the remote monitoring/surveillance service. As an example, a communication session may be initiated in response to a notification sent by a user (such as by indicating a request for a session with an input device of a notifier, with a voice command received through a notifier, etc.). As another example, a communication session may be automatically initiated based on certain events, such as when accelerometer data indicates a fall, when an alert is triggered with a notifier, etc.

In addition to or in lieu of a live conversation between a notifier user and an administrator of the remote monitoring/surveillance service, the communication session may instead simply be a live stream of video and/or audio data from the notifier to the back end server 120. If the notifier of a user is a cellular phone, tablet, etc., the video stream may come from the front and rear facing cameras of the phone, tablet, etc., to ensure adequate video coverage. Upon receiving and viewing the live stream of video and/or audio data, an administrator of the remote monitoring/surveillance service may evaluate the situation and take any needed actions (e.g., dispatching police or security, triggering an alarm, etc.). As noted above, the signal processing module 510 may be configured to send any video and/or audio data directly to a NAS channel on a cloud network video recorder (NVR).

As noted above, one or more notifiers may be embodied as a mobile device 124 (e.g., cellular phone, tablet, smart watch, or similar) that can communicate directly with the back end server 120 through Wi-Fi, cellular signals, etc. In that regard, the nuisance alert system 102 may include one or more applications (e.g., an iOS/Android app) for use with the mobile device 124 that provide at least some of the functionality of a notifier, such as the first notifier 108 described above. The user may download a nuisance alert system app (NAS app) onto the mobile device 124, and the user may interface with the NAS app to output one or more signals indicative of an alert, a request, etc. In that regard, a user can use the NAS app to generate an alarm, lock down a portion of the building, etc. Moreover, a user can interface with the NAS app to facilitate a communicate session with a remote administrator, record video and/or audio, and receive notifications (e.g., alerts initiated by other notifiers, updates, push notifications, etc.). Any data generated by the app can be sent to the signal processing module 510 of the back end server 120 for storing in the data store 506, for triggering a relay with the relay control 512, and/or for use by the management module 514 for monitoring, recording, tracking, etc.

In some examples, the management module 514 can be used to generate one or more reports using the data received from one or more of the gateway assembly 106, the controller 104, the notifiers, the output devices, the mobile device 124, and any other networked computing devices. In one example, any video data, image data, and/or audio data for an event may be retrieved from multiple devices (e.g., a mobile device 124 and a security camera) and compiled into one executable file in chronological order. The video data, image data, and/or audio data can then be easily used to generate a report, such as by inserting images or video/audio clips into the report, or otherwise using the video data, image data, and/or audio data to generate information for the report.

In some examples, the management module 514 can be used to locate a notifier(s), such as when an alert or request is initiated from a notifier in a larger securable space, such as a mall, a large office building, etc. Locating the notifier may help target where the nuisance activity is occurring. As such, other users of notifiers near the location can be correspondingly notified, output devices near that location can be triggered (e.g., alarms/cameras), doors in other areas outside the location can be locked or unlocked as needed, etc.

Location of a notifier(s) may be done in any suitable manner. For instance, in the “basic” nuisance alert system 102 referenced above, the management module 414 of the controller 104 may triangulate or otherwise overlay gateways and run an algorithm to determine the distance of the notifier to each gateway. Based on the algorithm results, the controller 104 can generate an output of the approximate location of the notifier. In some embodiments, such as the “virtual” nuisance alert system 102 referenced above, if the notifier is a mobile device, the management module 514 of the back end server 120 may determine the notifier location based on data retrieved from the GPS chip of the device.

In one aspect, the back end server 120 can implement software development tools, such as software development kits (SDKs) and Application Programming Interfaces (APIs) to integrate a third party surveillance/monitoring platforms into the nuisance alert system 102. In other words, SDKs and APIs can be used to facilitate communication between and integration of the management module 514 of the back end server 120 with other platforms (e.g., alarm center monitoring platforms, video monitoring software, etc.). For instance, data pertaining to the alarms and notifications generated by and for the notifiers, triggering of output devices, etc., can be sent to one or more other platforms for use with a corresponding interface.

The communication links shown in the nuisance alert system 102 may include uplink (UL) transmissions from one computing/mobile device to another, or from one computing/mobile device to a notifier/output device, and/or downlink (DL) transmissions, from one computing/mobile device to another, or from one computing/mobile device station to a notifier/output device. The downlink transmissions may also be called forward link transmissions while the uplink transmissions may also be called reverse link transmissions. Each communication link may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links may transmit bidirectional communications and/or unidirectional communications. Communication links may include one or more connections, including but not limited to, 345 MHz, Wi-Fi, BLUETOOTH®, BLUETOOTH® Low Energy, cellular, Z-WAVE®, MQTT, Zigbee, 802.11, peer-to-peer, LAN, WLAN, Ethernet, fire wire, fiber optic, and/or other connection types related to security and/or automation systems.

Each networked computing device may also communicate directly with each other via one or more direct communication links. Two or more devices may communicate via a direct communication link when both devices are in a predetermined geographic coverage area or when one or neither devices is within the geographic coverage area. Examples of direct communication links may include Wi-Fi Direct, BLUETOOTH®, wired, and/or, and other P2P group connections. The communication protocols may include WLAN radio and baseband protocol including physical and MAC layers from IEEE 802.11, and its various versions including, but not limited to, 802.11b, 802.11g, 802.11a, 802.11n, 802.11ac, 802.1 lad, 802.11ah, etc. In other implementations, other peer-to-peer connections and/or ad hoc networks may be implemented within the nuisance alert system 102.

In some embodiments, all of the elements shown in FIG. 1 need not be present to practice the present systems and methods. The devices and subsystems can be interconnected in different ways from that shown in FIG. 1. In some embodiments, an aspect of some operation of a system, such as that shown in FIG. 1, may be readily known in the art and are not discussed in detail in this application. Code to implement the present disclosure can be stored in a non-transitory computer-readable medium such as one or more of system memory or other memory. The operating system provided on controller 104 and/or back end server 120 may be iOS®, ANDROID®, MS-DOS®, MS-WINDOWS®, OS/2®, UNIX®, LINUX®, or another known operating system.

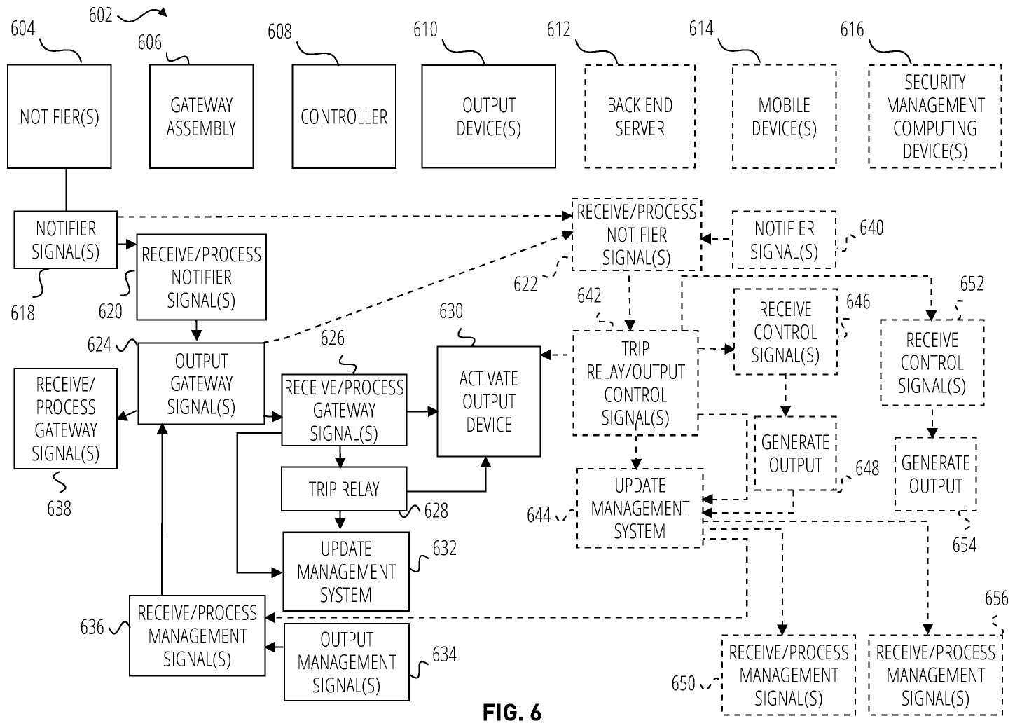

FIG. 6 is a swim diagram 602 outlining the various exemplary ways components of the nuisance alert system 102 can interact. The swim diagram 602 includes a notifier(s) 604, a gateway assembly 606, a controller 608, an output device(s) 610, a back end server 612, a mobile device(s) 614, and a security management computing device 616. Each of the devices may be examples of previous devices discussed herein. It should be appreciated that fewer or more than the components shown may be used for the nuisance alert system 102. For instance, in the “basic” nuisance alert system 102, the back end user interface device 122, mobile device(s) 614, and security management computing device 616 may not be included. Accordingly, those components and any interaction with those components is shown in dashed line for ease of reference. Moreover, for the “virtual” nuisance alert system 102, the controller 104 may be integrated into the back end user interface device 122. Accordingly, the description and illustration provided herein should not be seen as limiting.

At block 618, the notifier(s) 604 may generate a notifier signal based on one or more inputs received from a user of the notifier(s) 604, such as activation of an input device (e.g., a button, a voice command, an accelerometer sensor signal, etc.) The notifier signal may include an alert signal, a notification or warning signal, an alarm request signal, a door lock/unlock signal, an accelerometer signal, etc., which may be based upon the type of input received.

The notifier signal may also be generated automatically (e.g., without user input) based on a query from the gateway assembly 606 and/or controller 608 and/or back end server 612 and/or as a result of automatic scheduled notifications (such as programmed in the memory/processor of the notifier). For instance, the notifier signal may indicate a status of the notifier(s) 604, an identification of the notifier(s) 604, a location of the notifier(s) 604, etc.

The notifier signal(s) may be sent to the gateway assembly 606 and/or the back end server 612 for processing. For instance, at block 620, the notifier signal(s) may be received and processed by the gateway assembly 606, and at block 622, the notifier signal(s) may be received and processed by the back end server 612. If received by the gateway assembly 606, the gateway assembly 606 may process the notifier signal(s) and output one or more gateway signals at block 624, such as to the controller 608 and/or the back end server 612.

For instance, the gateway assembly 606 may process the notifier signal(s) and output one or more gateway signals to the controller 608 for processing. The controller 608 receives/processes the one or more gateway signals at block 626. Upon processing the one or more gateway signals at block 626, the controller 608 may, in one instance, trip a relay at block 628. For instance, if the one or more gateway signals are indicative of an alert, a notification or warning, an alarm request, a door lock/unlock request, a fall, etc., the controller 608 may trip a relay at block 628 to activate an output device at block 630, such as a camera, alarm, door lock, video and/or audio session, etc. If, on the other hand, the one or more gateway signals are indicative of a management update request (e.g., registration request, device status, location, etc.), the controller 608 may send the signals to its management module for processing (such as management module 414) at block 632.

If a management update needs to be sent to the notifier(s) 604, the controller 608 may output one or more signals at block 634 to the gateway assembly 606, which receives the one or more signals relating to a management update at block 636. Upon receiving/processing the one or more signals relating to a management update, the gateway assembly 606 may output one or more gateway signals at block 624 to the notifier(s) 604, which are received and processed by the notifier(s) 604 at block 638. For instance, the transceiver module 208 of a notifier may communicate with the identification assembly 204 to update the notifier and/or to output one or more signals (such as at block 618) in response to the or more signals relating to a management update (such as, for instance, providing any information in response to a request).

As noted above, the gateway assembly 606 may process the notifier signal(s) and output one or more gateway signals at block 624 to the back end server 612. For instance, the gateway assembly 606 may process the notifier signal(s) and output one or more gateway signals to the back end server 612 for processing. The back end server 612 receives/processes the one or more gateway signals at block 622. As noted above, the notifier(s) 604 may also send one or more signals directly to the back end server 612 without passing through the gateway assembly 606, such as when the notifier(s) 604 is a mobile device(s) 614. In that regard, the mobile device(s) 614 is shown, at block 640, outputting one or more notifier signals to the back end server 612, which is received/processed at block 622.

Upon processing the one or more notifier signals at block 622, the back end server 612 may, in one instance, trip a relay at block 642. For instance, if the one or more notifier signals are indicative of an alert, a notification or warning, an alarm request, a door lock/unlock request, a fall, etc., the back end server 612 may trip a relay at block 642 to activate an output device at block 630, such as a camera, alarm, door lock, video and/or audio session, etc. At block 642, the back end server 612 may instead or additionally output a control signal(s) indicative of the notifier signal(s), the corresponding relay tripped, or other relative data, which may be received, for instance, by a management module (such as management module 514) of the back end server 612 at block 644. The management module may store the data in a data store (such as data store 506) for retrieval by any of the applications of the back end server 612 and/or the controller 608.

At block 642, the back end server 612 may instead or additionally output a control signal(s) indicative of a desired output to the mobile device(s) 614. The mobile device(s) 614 may receive the control signal(s) at block 646, and as a result, the mobile device(s) 614 may generate an output(s) at block 648, such as initiating a communication session with the user, recording/monitoring/live streaming audio/video/images, providing a notification (e.g., vibration, light, sound, etc.), etc. Any data captured by or generated by the mobile device(s) 614 may be outputted to the back end server 612 for updating the management system (such as with management module 514). In that regard, the back end server 612 may receive any mobile device data and update the management system at block 644.

If a management update needs to be sent to the notifier(s) 604, the back end server 612 may output one or more signals at block 644 to the gateway assembly 606, which receives the one or more signals relating to a management update at block 636. Upon receiving/processing the one or more signals relating to a management update, the gateway assembly 606 may output one or more gateway signals at block 624 to the notifier(s) 604, which are received and processed by the notifier(s) 604 at block 638. For instance, the transceiver module 208 of a notifier may communicate with the identification assembly 204 to update the notifier and/or to output one or more signals (such as at block 618) in response to the or more signals relating to a management update (such as, for instance, providing any information in response to a request). If a management update needs to be sent to the mobile device(s) 614, the back end server 612 may output one or more signals at block 644 to the mobile device(s) 614, which receives the one or more signals relating to a management update at block 650.

At block 642, the back end server 612 may instead or additionally output a control signal(s) indicative of a desired output to the security management computing device 616. The security management computing device 616 may receive the control signal(s) at block 646, and as a result, the security management computing device 616 may generate an output(s) at block 648, such as initiating a communication session with the user, recording/monitoring/live streaming audio/video/images, providing a notification (e.g., vibration, light, sound, etc.), providing a location of a notifier with which an alert was generated (such as with triangulation or using GPS data), etc.

Any data captured by or generated by the security management computing device 616 may be outputted to the back end server 612 for updating the management system (such as with management module 514). In that regard, the back end server 612 may receive any security management computing device data and update the management system at block 644. If a management update needs to be sent to the security management computing device 616, the back end server 612 may output one or more signals at block 644 to the security management computing device 616, which receives the one or more signals relating to a management update at block 656.

It should be appreciated that the interaction of components of the nuisance alert system 102 shown in swim diagram 602 is exemplary only, and fewer or more interactions may occur as is necessary for carrying out the functionality of the nuisance alert system 102. For instance, as noted above, the component interaction may depend on the configuration of the nuisance alert system 102, such as whether it is a basic system, a virtual system, a combination of both, or another configuration. Further, if the nuisance alert system 102 is configured as a virtual-type system with many notifier locations managed by a back end server 612 (and optionally one or more controllers 608), additional communications between components may be used to support a centrally managed system having numerous managed sites. Accordingly, FIG. 6 should not be seen as limiting.

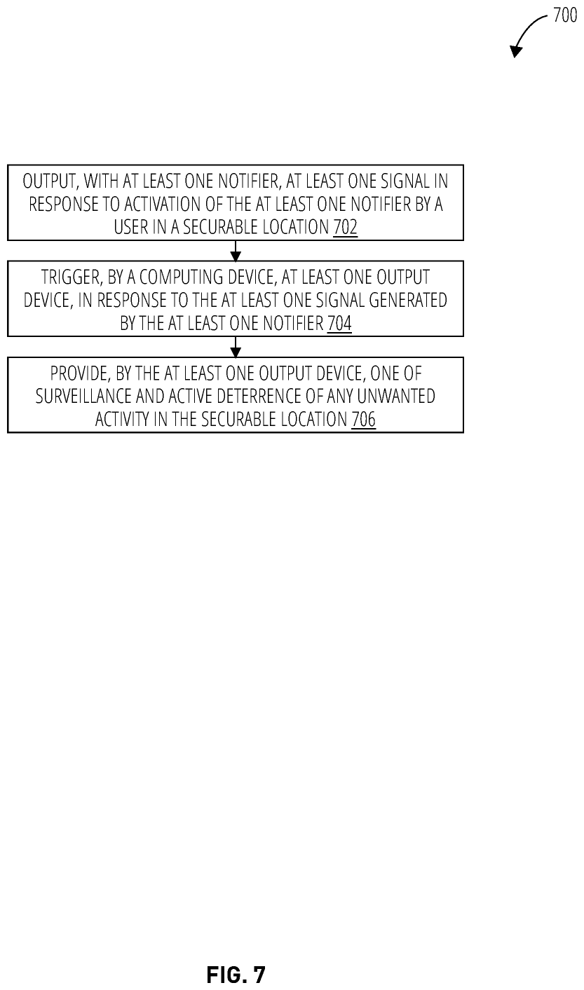

Referring to FIG. 7, an exemplary method 700 of providing at least one of surveillance and active deterrence of any unwanted activity in a securable location according to aspects of the present disclosure will now be described. The method 700 may be carried out using some or all of the components of the nuisance alert system 102 described herein, such as the notifier(s) 108, 110, and/or 604, the gateway assembly 106 and/or 606, the controller 104 and/or 608, the output device(s) (e.g., electronic lock 112 and camera 114), and/or 610, the back end server 120 and/or 612, the mobile device 124 and/or 614, and the security management computing device 126 and/or 616. It should be appreciated that fewer or more than the components shown in FIGS. 1 and 6, for instance, may be used for carrying out method 700.

For instance, in the “basic” nuisance alert system 102, the method may include using the notifier(s) 108, 110, and/or 604, the gateway assembly 106 and/or 606, the controller 104 and/or 608, and the output device(s) (e.g., electronic lock 112 and camera 114), and/or 610, and the back end server 120 and/or 612, the mobile device 124 and/or 614, and the security management computing device 126 and/or 616 may not be included. Moreover, in the “virtual” nuisance alert system 102, the method may include using the notifier(s) 108, 110, and/or 604, the gateway assembly 106 and/or 606, the controller 104 and/or 608, the output device(s) (e.g., electronic lock 112 and camera 114), and/or 610, the back end server 120 and/or 612, the mobile device 124 and/or 614, and the security management computing device 126 and/or 616. Moreover, for the “virtual” nuisance alert system 102, the controller 104 and/or 608 may be integrated into the back end server 120 and/or 612. Accordingly, any method steps that may be carried out by the controller 104 and/or 608 may instead be carried out by the back end server 120 and/or 612. Thus, the description and illustration provided herein should not be seen as limiting.

In block 702, the method 700 may include outputting, with at least one notifier, at least one signal in response to activation of the at least one notifier by a user in a securable location.

For instance, the notifier(s) 108, 110, and/or 604 may generate a notifier signal based on one or more inputs received from a user of the notifier(s), such as activation of an input device (e.g., a button, a voice command, an accelerometer sensor signal, etc.) The notifier signal may include an alert signal, a notification or warning signal, an alarm request signal, a door lock/unlock signal, an accelerometer signal, etc., which may be based upon the type of input received.

The notifier signal may also be generated automatically (e.g., without user input) based on a query from the gateway assembly 106 and/or 606 and/or controller 104 and/or 608 and/or back end server 120 and/or 612 and/or as a result of automatic scheduled notifications (such as programmed in the memory/processor of the notifier). For instance, the notifier signal may indicate a status of the notifier(s), an identification of the notifier(s), a location of the notifier(s), etc.

The notifier signal(s) may be sent to the gateway assembly and/or the back end server for processing. If received by the gateway assembly, the gateway assembly may process the notifier signal(s) and output one or more gateway signals, such as to the controller and/or the back end server. For instance, the gateway assembly may process the notifier signal(s) and output one or more gateway signals to the controller for processing. The controller receives/processes the one or more gateway signals.

As noted above, the gateway assembly may process the notifier signal(s) and output one or more gateway signals to the back end server for processing. In such an instance, the back end server receives/processes the one or more gateway signals. As noted above, the notifier(s) may also send one or more signals directly to the back end server without passing through the gateway assembly, such as when the notifier(s) is a mobile device(s) (such as mobile device 124 and/or 614).

In block 704, the method 700 may include triggering, by a computing device, at least one output device, in response to the at least one signal generated by the at least one notifier.

For instance, upon processing the one or more gateway signals at block, the controller may, in one instance, trip a relay. For example, if the one or more gateway signals are indicative of an alert, a notification or warning, an alarm request, a door lock/unlock request, a fall, etc., the controller may trip a relay to activate an output device at block, such as a camera, alarm, door lock, video and/or audio session, etc. (e.g., output device(s) 112, 114, and/or 610). If, on the other hand, the one or more gateway signals are indicative of a management update request (e.g., registration request, device status, location, etc.), the controller may send the signals to its management module for processing (such as management module 414).

If a management update needs to be sent to the notifier(s), the controller may output one or more signals to the gateway assembly, which receives the one or more signals relating to a management update. Upon receiving/processing the one or more signals relating to a management update, the gateway assembly may output one or more gateway signals to the notifier(s), which are received and processed by the notifier(s). For instance, the transceiver module 208 of a notifier may communicate with the identification assembly 204 to update the notifier and/or to output one or more signals in response to the or more signals relating to a management update (such as, for instance, providing any information in response to a request).

As noted above, the gateway assembly may process the notifier signal(s) and output one or more gateway signals to the back end server. For instance, the gateway assembly may process the notifier signal(s) and output one or more gateway signals to the back end server for processing. The back end server may receive/process the one or more gateway signals. As noted above, the notifier(s) may also send one or more signals directly to the back end server without passing through the gateway assembly, such as when the notifier(s) is a mobile device(s).

Upon processing the one or more notifier signals, the back end server may, in one instance, trip a relay. For instance, if the one or more notifier signals are indicative of an alert, a notification or warning, an alarm request, a door lock/unlock request, a fall, etc., the back end server may trip a relay to activate an output device, such as a camera, alarm, door lock, video and/or audio session, etc. The back end server may instead or additionally output a control signal(s) indicative of the notifier signal(s), the corresponding relay tripped, or other relative data, which may be received, for instance, by a management module (such as management module 514) of the back end server. The management module may store the data in a data store (such as data store 506) for retrieval by any of the applications of the back end server and/or the controller.

The back end server may instead or additionally output a control signal(s) indicative of a desired output to the mobile device(s). The mobile device(s) may receive the control signal(s), and as a result, the mobile device(s) may generate an output(s), such as initiating a communication session with the user, recording/monitoring/live streaming audio/video/images, providing a notification (e.g., vibration, light, sound, etc.), etc. Any data captured by or generated by the mobile device(s) may be outputted to the back end server for updating the management system (such as with management module 514). In that regard, the back end server may receive any mobile device data and update the management system.

If a management update needs to be sent to the notifier(s), the back end server may output one or more signals to the gateway assembly, which receives the one or more signals relating to a management update. Upon receiving/processing the one or more signals relating to a management update, the gateway assembly may output one or more gateway signals to the notifier(s), which are received and processed by the notifier(s). For instance, the transceiver module of a notifier may communicate with the identification assembly to update the notifier and/or to output one or more signals in response to the or more signals relating to a management update (such as, for instance, providing any information in response to a request). If a management update needs to be sent to the mobile device(s), the back end server may output one or more signals to the mobile device(s), which receives the one or more signals relating to a management update.

The back end server may instead or additionally output a control signal(s) indicative of a desired output to a security management computing device (such as security management computing device 616). The security management computing device may receive the control signal(s), and as a result, the security management computing device may generate an output(s), such as initiating a communication session with the user, recording/monitoring/live streaming audio/video/images, providing a notification (e.g., vibration, light, sound, etc.), providing a location of a notifier with which an alert was generated (such as with triangulation or using GPS data), etc.

Any data captured by or generated by the security management computing device may be outputted to the back end server for updating the management system (such as with management module 514). In that regard, the back end server may receive any security management computing device data and update the management system. If a management update needs to be sent to the security management computing device, the back end server may output one or more signals to the security management computing device, which receives the one or more signals relating to a management update.

In block 706, the method 700 may include providing, by the at least one output device, one of surveillance and active deterrence of any unwanted activity in the securable location, such as with one or more of the steps or aspects described above.

For instance, in one aspect, the method 700 may further include at least one of: viewing, with a computer device, video or image data captured by at least one output device; listening to, with a computing device, audio data captured by at least one output device; and registering and managing, with a computing device, a plurality of notifiers each associated with at least one user.

In another aspect, the method 700 may further include at least one of: viewing, with a computer device, video or image data captured by at least one output device; listening to, with a computing device, audio data captured by at least one output device; engaging, with a computing device, the user associated with the at least one notifier that outputted the at least one signal; communicating, with a computing device, a location of the at least one notifier that outputted the at least one signal to a security management computing device, dispatching, with a computing device, security personnel to the securable location, and registering and managing, with a computing device, a plurality of notifiers each associated with at least one user.

In another aspect, the method 700 may further include generating, with an input assembly of the at least one notifier, at least one of an alert for indicating a nuisance activity, a request for triggering an output device, a door lock request, and a fall indication.

In another aspect, the method 700 may further include generating at least one of an alarm, activating lights, locking a door, initiating a communication session with a user of the at least one notifier, recording audio and/or visual and/or image data with the at least one notifier, sending location information of the at least one notifier, activating a vibratory motor of at least one other notifier, and generating an audio or visual notification on at least one notifier when triggering, by a computing device, the at least one output device in response to the at least one signal generated by the at least one notifier.

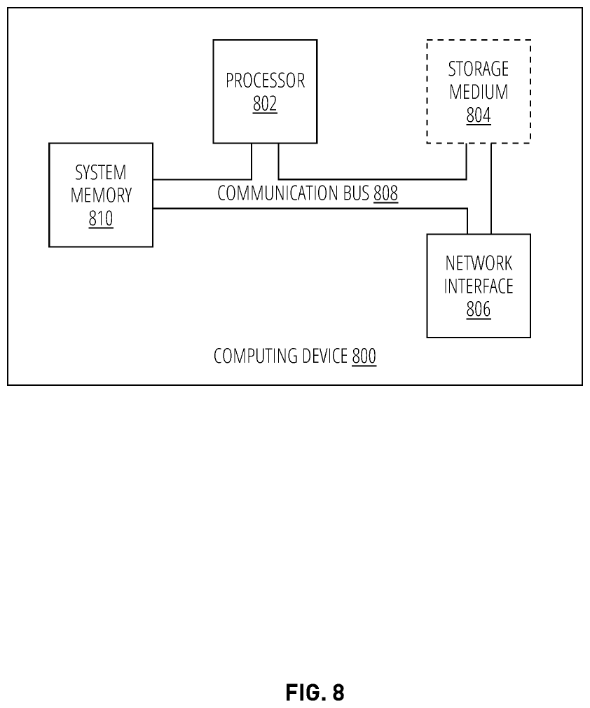

FIG. 8 is a block diagram that illustrates aspects of an exemplary computing device 800 appropriate for use as a computing device of the present disclosure. While multiple different types of computing devices were discussed above, the exemplary computing device 800 describes various elements that are common to many different types of computing devices. While FIG. 8 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 800 may be any one of any number of currently available or yet to be developed devices.

In its most basic configuration, the computing device 800 includes at least one processor 802 and a system memory 810 connected by a communication bus 808. Depending on the exact configuration and type of device, the system memory 810 may be volatile or nonvolatile memory, such as read only memory (“ROM”), random access memory (“RAM”), EEPROM, flash memory, or similar memory technology. Those of ordinary skill in the art and others will recognize that system memory 810 typically stores data and/or program modules that are immediately accessible to and/or currently being operated on by the processor 802. In this regard, the processor 802 may serve as a computational center of the computing device 800 by supporting the execution of instructions.

As further illustrated in FIG. 8, the computing device 800 may include a network interface 806 comprising one or more components for communicating with other devices over a network. Embodiments of the present disclosure may access basic services that utilize the network interface 806 to perform communications using common network protocols. The network interface 806 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 806 illustrated in FIG. 8 may represent one or more wireless interfaces or physical communication interfaces described and illustrated above with respect to particular components of the computing device 800.

In the exemplary embodiment depicted in FIG. 8, the computing device 800 also includes a storage medium 804. However, services may be accessed using a computing device that does not include means for persisting data to a local storage medium. Therefore, the storage medium 804 depicted in FIG. 8 is represented with a dashed line to indicate that the storage medium 804 is optional. In any event, the storage medium 804 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 802, system memory 810, communication bus 808, storage medium 804, and network interface 806 are known and commercially available. For ease of illustration and because it is not important for an understanding of the claimed subject matter, FIG. 8 does not show some of the typical components of many computing devices. In this regard, the computing device 800 may include input devices, such as a keyboard, keypad, mouse, microphone, touch input device, touch screen, tablet, and/or the like. Such input devices may be coupled to the computing device 800 by wired or wireless connections including RF, infrared, serial, parallel, Bluetooth, Bluetooth low energy, USB, or other suitable connections protocols using wireless or physical connections. Similarly, the computing device 800 may also include output devices such as a display, speakers, printer, etc. Since these devices are well known in the art, they are not illustrated or described further herein.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

Systems implementing methods according to this disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example. The instructions, media for conveying such instructions, computing resources for executing them, and other structures for supporting such computing resources are means for providing the functions described in these disclosures.

References in the specification to “one embodiment,” “an embodiment,” “an exemplary embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Headings of sections provided in this patent application and the title of this patent application are for convenience only and are not to be taken as limiting the disclosure in any way.

While preferred embodiments of the present invention have been shown and described herein, it will be apparent to those skilled in the art that such embodiments are provided by way of example only. Numerous variations, changes, and substitutions will now occur to those skilled in the art without departing from the invention. Various alternatives to the embodiments of the invention described herein may be employed in practicing the invention. It is intended that the following claims define the scope of the invention and that methods and structures within the scope of these claims and their equivalents be covered thereby.

What is claimed is:

1. A nuisance alert system configured to provide at least one of surveillance and active deterrence of any unwanted activity in a securable location, comprising:
at least one notifier configured to output at least one signal in response to activation of the at least one notifier by a user in a securable location; and
at least one output device configured to be triggered in response to the at least one signal generated by the at least one notifier, the at least one output device configured to, when triggered, provide one of surveillance and active deterrence of any unwanted activity in the securable location.

2. The nuisance alert system of claim 1, further comprising a gateway assembly in communication with the at least one notifier and the at least one output device, the gateway assembly configured to process the at least one signal from the at least one notifier and communicate the processed at least one signal from the at least one notifier to a controller.

3. The nuisance alert system of claim 2, wherein the controller includes a processor, a computer-readable memory, and computer code stored in the computer-readable memory for causing the processor to operate the controller to process signals received by the gateway assembly from the at least one notifier for performing at least one of:
triggering the at least one output device;
viewing video or image data captured by at least one output device;
listening to audio data captured by at least one output device; and
registering and managing a plurality of notifiers each associated with at least one user.

4. The nuisance alert system of claim 3, further comprising a front end user device having a processor, a computer-readable memory, and computer code stored in the computer-readable memory for causing the processor to operate the front end user device to provide a front end user interface for at least one of registering and managing a plurality of notifiers each associated with at least one user, wherein the front end user device is in communication with the controller via a network.

5. The nuisance alert system of claim 3, further comprising a back end user device having a processor, a computer-readable memory, and computer code stored in the computer-readable memory for causing the processor to operate the back end user device to receive and provide one or more signals from one of the gateway assembly and the controller for performing at least one of:
triggering at least one output device;
viewing video or image data captured by at least one output device when triggered;
listening to audio data captured by at least one output device when triggered;
engaging the user associated with the at least one notifier that outputted the at least one signal;
communicating a location of the at least one notifier that outputted the at least one signal to a security management computing device;
dispatching security personnel to the securable location; and
registering and managing a plurality of notifiers each associated with at least one user.

6. The nuisance alert system of claim 2, further comprising a back end user device having a processor, a computer-readable memory, and computer code stored in the computer-readable memory for causing the processor to operate a back end user device to receive and provide one or more signals from one of the gateway assembly and the at least one notifier, the back end user interface configured for performing at least one of:
triggering at least one output device;
viewing video or image data captured by at least one output device when triggered;
listening to audio data captured by at least one output device when triggered;
engaging the user associated with the at least one notifier that outputted the at least one signal;
communicating a location of the at least one notifier that outputted the at least one signal to a security management computing device;
dispatching security personnel to the securable location; and
registering and managing a plurality of notifiers each associated with at least one user.

7. The nuisance alert system of claim 1, wherein the at least one notifier has an input assembly including at least one of an alert input subassembly, a lock down input subassembly, a door unlock assembly, a digital accelerometer, a microphone, and a motion sensor.

8. The nuisance alert system of claim 7, wherein the input assembly of the at least one notifier is configured to generate at least one of an alert for indicating a nuisance activity, a request for triggering an output device, a door lock request, and a fall indication.

9. The nuisance alert system of claim 8, further comprising a back end user device having a processor, a computer-readable memory, and computer code stored in the computer-readable memory for causing the processor to operate a back end user device to receive and provide one or more signals from one of a gateway assembly in communication with the at least one notifier, a controller in communication with the gateway assembly, and the at least one notifier, the back end user interface configured for performing at least one of:
triggering at least one output device in response to an input request from the at least one notifier indicative of a request for triggering an output device;
viewing video or image data captured by at least one output device when triggered;
listening to audio data captured by at least one output device when triggered;
engaging the user associated with the at least one notifier that outputted the at least one signal;
communicating a location of the at least one notifier that outputted the at least one signal to a security management computing device;
dispatching security personnel to the securable location; and
registering and managing a plurality of notifiers each associated with at least one user.

10. The nuisance alert system of claim 7, wherein the at least one notifier includes a notification assembly configured to output at least one notification in response to one or more signals received from a computing device in communication with the at least one notifier.

11. The nuisance alert system of claim 1, wherein the at least one output device is one of an alarm, a camera, a door lock, a speaker, a vibratory motor, a light, and a graphical display.

12. A method of providing at least one of surveillance and active deterrence of any unwanted activity in a securable location, comprising:
outputting, with at least one notifier, at least one signal in response to activation of the at least one notifier by a user in a securable location;
triggering, by a computing device, at least one output device, in response to the at least one signal generated by the at least one notifier; and
providing, by the at least one output device, one of surveillance and active deterrence of any unwanted activity in the securable location.

13. The method of claim 12, further comprising:
viewing, with a computer device, video or image data captured by at least one output device;
listening to, with a computing device, audio data captured by at least one output device; and
registering and managing, with a computing device, a plurality of notifiers each associated with at least one user.

14. The method of claim 12, further comprising:
viewing, with a computer device, video or image data captured by at least one output device;
listening to, with a computing device, audio data captured by at least one output device;
engaging, with a computing device, the user associated with the at least one notifier that outputted the at least one signal;
communicating, with a computing device, a location of the at least one notifier that outputted the at least one signal to a security management computing device;
dispatching, with a computing device, security personnel to the securable location; and
registering and managing, with a computing device, a plurality of notifiers each associated with at least one user.

15. The method of claim 12, further comprising generating, with an input assembly of the at least one notifier, at least one of an alert for indicating a nuisance activity, a request for triggering an output device, a door lock request, and a fall indication.

16. The method of claim 12, further comprising generating at least one of an alarm, activating lights, locking a door, initiating a communication session with a user of the at least one notifier, recording audio and/or visual and/or image data with the at least one notifier, sending location information of the at least one notifier, activating a vibratory motor of at least one other notifier, and generating an audio or visual notification on at least one notifier when triggering, by a computing device, the at least one output device in response to the at least one signal generated by the at least one notifier.
